(19) United States
(12) Patent Application Publication
(10) Pub. No.: US 2003/0011153 A1
(43) Pub. Date: Jan. 16, 2003

(54) Nose plate attachment for stackable open front grocery and goods bin

(76) Inventor: William B. Trescott, Sargent, TX (US)

Correspondence Address: William B. Trescott, 8028 Hwy 457, Bay City, TX, 77414, US

(21) Appl. No.: 09/901,303

(22) Filed: Jul. 10, 2001

(51) Int. Cl. B62B 3/00; B62B 1/00

(52) U.S. Cl. 280/43; 280/29; 280/33.991

(57) ABSTRACT

The present invention is a fork lift attachment for lifting Stackable Open Front Grocery and Goods Bins with Air Cushion Mobility. It can be equipped with wheels to function as a stand alone cart.

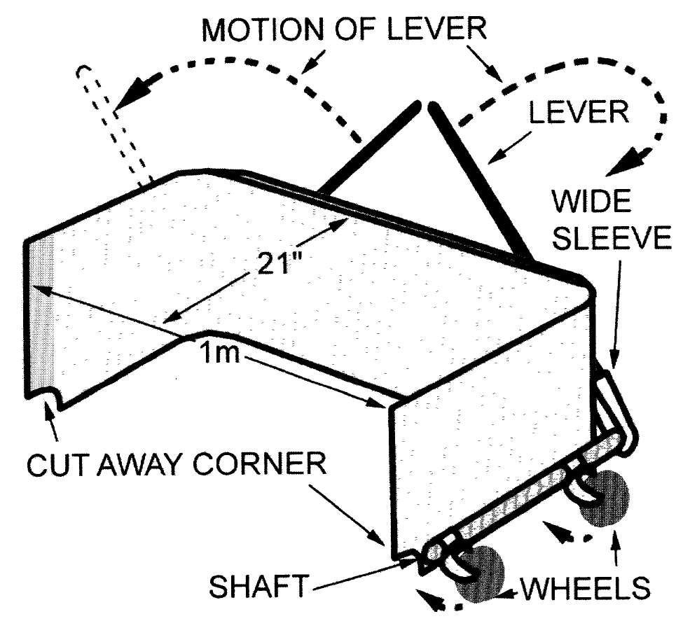

### RELATED APPLICATIONS

Stackable Open Front Grocery and Goods Bin with Air Cushion Mobility and Loading and Sorting Conveyer.

### FEDERAL SPONSORSHIP

none

### BACKGROUND

1. Field of the Invention

The present invention pertains to the art of transporting goods—it is a type of attachment for a fork lift truck that can also be used as a cart.

2. Statement of the Problem

The Stackable Open Front Grocery and Goods Bin with Air Cushion Mobility is designed to float on a cushion of compressed air like a hovercraft, but this can only be done a hose length away from a compressed air source. The air cushion lip on the bottom of the bin is likely to be damaged if the bin is dragged across a rough surface. People who use material handling equipment such as fork lift trucks and pallet jacks would like to have a device which would allow their present material handling equipment to carry the new bins.

### SUMMARY OF THE INVENTION

Solution to the Problem:

The present invention fits on the front of a fork lift truck in place of the forks. It fits around the back of a stack of bins and supports the bottom bin properly so that the stack can be carried a great distance. By tilting the truck's mast, the bins can be carried at an angle to prevent the contents from falling out of the bins. Fitted with wheels, the present invention can be used as a stand alone cart.

### BRIEF DESCRIPTION OF THE DRAWING

The nose plate attachment fitted with wheels is shown along with the lever movement to raise a stack of bins.

### DESCRIPTION OF THE PREFERRED EMBODIMENT

1. Overview

The present invention consists of a ‘U’ shaped plate, preferably of metal or composite material. The top front corners are rounded to prevent sharp object injuries. The bottom front corners are cut away so that an air hose can be attached to the bin with the present invention attached. The rear edge is turned outward and downward to fit the nose plate of a fork lift truck. Additional methods of attachment can be added to adapt the present invention to fit different makes of lift trucks and pallet jacks.

2. Wheels

Retractable wheels can be added to allow the present invention to be used as a stand alone cart. The wheels should castor so that the cart can turn corners. They should be mounted to a shaft rotated by a lever so that the operator can slide the attachment under the back of a stack of bins and lift the stack by pulling on the levers one at a time. The levers should rock from side to side in their mounting sleeve so that they can press alongside the stack bins to hold the bins off the floor and also to prevent the levers from being snagged on foreign objects as the stack is being pulled. The levers should be removable so as not to prevent attachment to a fork lift with the wheels mounted.

3. Dimensions

The preferred dimensions of the present invention are 1 meter wide (outer dimension not including wheels) and 21 inches deep (inner dimension). The height should be 1 foot minus one half of the diameter of the wheels.

What is claimed:

1. A “U” shaped fork lift attachment for lifting and transporting Stackable Open Front Grocery and Goods Bins

2. The device in claim 1 with wheels

3. The wheels in claim 2 attached to a shaft equipped with levers to raise and lower the wheels

4. A wide sleeve holding the levers to the shaft in claim 3 which allows the levers to be tipped along side the stack of bins and press against the bins to hold the stack off the floor.
